(19) United States
(12) Patent Application Publication
(10) Pub. No.: US 2025/0300590 A1
(43) Pub. Date: Sep. 25, 2025

(54) SOLAR PANEL MOUNT WITH SEALING STRUCTURE

(71) Applicant: Unirac, Inc., Albuquerque, NM (US)

(72) Inventor: Ronald Gary Norman, Louisville, CO (US)

(21) Appl. No.: 19/076,630

(22) Filed: Mar. 11, 2025

Related U.S. Application Data
(60) Provisional application No. 63/568,366, filed on Mar. 21, 2024.

(51) Int. Cl. H02S 20/20; F24S 25/00; F24S 25/10

(52) U.S. Cl. CPC H02S 20/20; F24S 25/10; F24S 2025/021

(57) ABSTRACT

A mount attaches solar panel modules to a surface. The mount includes a base, a groove formed in the base, one or more apertures disposed through the base, a first port fluidly connected to the groove, a second port fluidly connected to the groove, and a stanchion extending from the base. The one or more apertures receive a first fastener for attaching the mount to the surface. The first port is used to inject a sealant into the groove and the second port permits air within the groove to vent as the sealant is injected into the groove. The stanchion has a channel to receive a second fastener for attaching the solar panel modules to the mount.

### CROSS-REFERENCE TO RELATED APPLICATIONS

This application claims priority to U.S. Provisional Patent Application No. 63/568,366, filed Mar. 21, 2024, entitled “Flashing-less Attachment Apparatus and Methods Thereof,” the entirety of which is herein incorporated by reference.

### BACKGROUND

The solar power industry continues to grow and, as a result, installation time and integrity remain critical. Generally, mounts secure solar panel modules to a surface using fasteners. Moreover, to prevent an ingress of liquid into the surface, sealant is often disposed around the mount, within the mount, or within a cavity of the mount through which the fasteners are disposed. However, oftentimes, the sealant fails to adequately seal the mount to the surface and/or an excessive amount of sealant is used to seal the mount to the surface.

### BRIEF DESCRIPTION OF THE DRAWINGS

FIG. 1 illustrates a top isometric view of an example mount, according to an embodiment of the present disclosure.

FIG. 2 illustrates a bottom isometric view of the mount of FIG. 1, according to an embodiment of the present disclosure.

FIG. 3 illustrates a top planar view of the mount of FIG. 1, according to an embodiment of the present disclosure.

FIG. 4 illustrates a bottom planar view of the mount of FIG. 1, according to an embodiment of the present disclosure.

FIG. 5 illustrates an exploded isometric view of an example mount, according to an embodiment of the present disclosure.

FIG. 6 illustrates a bottom isometric view of the mount of FIG. 5, according to an embodiment of the present disclosure.

FIG. 7 illustrates a top isometric view of an example mount, according to an embodiment of the present disclosure.

FIG. 8 illustrates a bottom isometric view of the mount of FIG. 7, according to an embodiment of the present disclosure.

FIG. 9 illustrates a top isometric view of an example mount, showing a cross-sectional view of an inlet port of the mount, taken along line A-A of FIG. 9, according to an embodiment of the present disclosure.

FIG. 10 illustrates a top isometric view of an example mount, according to an embodiment of the present disclosure.

FIG. 11 illustrates a bottom isometric view of an example mount, according to an embodiment of the present disclosure.

FIG. 12 illustrates a cross-sectional view of the mount of FIG. 11, taken along line B-B of FIG. 11, according to an embodiment of the present disclosure.

FIG. 13 illustrates a bottom isometric view of an example mount, according to an embodiment of the present disclosure.

FIG. 14 illustrates a cross-sectional view of the mount of FIG. 13, taken along line C-C of FIG. 13, according to an embodiment of the present disclosure.

FIG. 15 illustrates a first isometric view of an example mount, according to an embodiment of the present disclosure.

FIG. 16 illustrates a second isometric view of the mount of FIG. 15, according to an embodiment of the present disclosure.

### DETAILED DESCRIPTION

This application is directed, at least in part, to a mount configured to attach solar panel modules to a surface and a sealing structure that seals the mount against the surface, according to an embodiment of the present disclosure. In an embodiment, the mount may represent a structure that secures to the surface, such as a roof, via one or more fasteners. The sealing structure may include a seal that seals the mount against the surface to prevent an ingress of liquid into penetrations in the surface created by the one or more fasteners. In an embodiment, the sealing structure may additionally or alternatively seal around the one or more fasteners. In an embodiment, the solar panel modules, whether indirectly or directly, may attach to the mount. Use of the mount with the sealing structure may reduce installation times, complexities, and reduce the risk of liquid permeating into the surface.

The mount may include a base and a stanchion that extends from the base. The base may include a bottom that is disposed against the surface, and a top, opposite the bottom, from which the stanchion extends. One or more apertures (e.g., through holes, channels, etc.) may be disposed through the base, from the top to the bottom, for receiving the one or more fasteners, respectively, that attach the mount to the surface. For example, individual aperatures may receive individual fasteners. In an embodiment, the base may include any number of the apertures that receive the fasteners, respectively. Moreover, the apertures may be disposed at any suitable location on the base, such as at corners, along a central axis, within a center, and/or any combination thereof. The mount may be a monolithic or unitary body formed from plastic, metal (e.g., aluminum), composites, etc. In addition, the base may include any suitable footprint, such as being rectangular, circular, ovular, etc.

The base may define a groove (e.g., channel, cavity, trench, etc.) formed on the bottom. The groove may accommodate the sealing structure, which, as described herein, may represent a sealant, gasket, washer, seal, etc., disposed within the groove. Example materials of the sealing structure may include butyl, silicon, acrylic, polyurethane, rubber, etc. The sealing structure may be disposed around, enclose, surround, etc., the fasteners to seal the penetrations formed in the surface. In an embodiment, the groove may be formed in less than an entirety of the bottom. For example, a footprint of the base may define a first area and the groove may define a second area that is less than the first area. Conventionally, an entirety of the bottom (or a cavity in the bottom) may be filled with sealant, or the sealant may be disposed across an entirety of the bottom, to seal against the surface. This, however, may represent an inefficient use of materials and lead to increased installation times. The sealing structure as described herein, by way of comparison, may locally seal around the penetrations to avoid such waste and increase the speed at which the mounts are attached to the surface.

In an embodiment, the groove may zig-zag, crisscross, serpentine, etc., along the bottom. For example, from a first end to a second end of the base, the groove may zig-zag between a first side and second side. The shape of the groove may be based at least in part on the locations of the apertures in the base. When the fasteners are disposed through the base, the fasteners are disposed at a location within the groove. For example, the fasteners may intersect the groove such that as the fasteners are disposed in the surface, the shafts of the fasteners are disposed within the groove. Moreover, when the sealant is disposed within the groove, the sealant may seal around the fasteners. For example, the fasteners may be disposed through or within the sealant. The groove may also accommodate all the fasteners. For example, if the base includes six of the apertures, the groove may extend between the six apertures. In an embodiment, the groove may be formed via sidewalls, edges, etc., in the bottom.

The groove may also be disposed around a perimeter of the base. In an embodiment, when disposed around the perimeter, the fasteners may not intersect the groove. Instead, the fasteners may be disposed internal to, such as within a perimeter of, the groove. However, in this embodiment, the sealant structure may prevent an ingress of liquid into the penetration despite the fasteners not being disposed through the groove.

As introduced above, the sealing structure may represent any suitable sealant, gasket, washer, seal, etc. In an embodiment, the sealing structure may be liquid, injectable, adhesive, flowable, or non-flowable. An example sealing structure may include a sealant, such as butyl, whether flowable or non-flowable. When embodied as a liquid, injectable, flowable, etc., sealant, the base may define one or more inlet ports and one or more outlet ports. The inlet port may represent a location at which the sealant is injectable (e.g., via a caulk gun, instrument, etc.) into the groove. For example, the sealant may be injected into the groove via the inlet port. The outlet port may permit air to escape the groove as the sealant is injected into the groove. That is, as the sealant is injected into the groove and flows or otherwise moves throughout the groove, between the inlet port and the outlet port, the sealant may occupy the groove and force the air out of the outlet port. The sealant may exit the outlet port to provide an indication to an installer that the groove is filled.

Sidewalls of the groove aid in directing the sealant between the inlet port and the outlet port. Ends of the sidewall may be disposed along the surface. Moreover, the groove is enclosed along a bottom via the surface. In embodiments where the sealant is injectable, the sealant may be injected into the groove after attaching the base to the surface via the fasteners.

In an embodiment, the groove may be a continuous groove, between the inlet port and the outlet port. Alternatively, the base may include more than one groove, where each groove may have a respective inlet port and an outlet port. A first groove may accommodate first fasteners of the fasteners, while a second groove may accommodate second fasteners of the fasteners. Accordingly, more than one groove may be used to seal around the fasteners. The seals may be different or similar to one another in size, shape, the number of fasteners they accommodate, etc.

The inlet ports and the outlet ports may represent orifices, nozzles, apertures, etc. In an embodiment, the inlet port and/or the outlet port may be universal, such that the inlet port and the outlet port may be used universally as either injection locations or vent locations. Alternatively, the inlet port and the outlet port may be different. For example, the inlet port may include a larger cross-sectional dimension than the inlet port. In an embodiment, the inlet port may be tapered to accept a nozzle or neck of a caulk tube. In an embodiment, the inlet ports and/or the outlet ports may be located along the top and/or the sides of the base. In an embodiment, the location of the inlet port and the outlet port may promote the flow of sealant throughout the groove. For example, the inlet port and the outlet port may be spaced apart from one another between sides, ends, etc., of the base. Alternatively, the inlet port and the outlet port may be diametrically opposed from one another. Yet still, the inlet port may be located at a first end of the groove and the outlet port may be located at a second end of the groove. Regardless of the specific implantation, spacing the inlet port and the outlet port apart from one another in this manner assists in dispersing the sealant throughout an entirety of the channel as the sealant flows (e.g. moves, disperses, etc.,) from the inlet port to the outlet port. Comparatively, if the inlet port and the outlet port were close in proximity, the sealant (when injected) may tend to exit the outlet port before filling an entirety of the groove.

Features of the groove may also assist in promoting the flow of the sealant through the groove. For example, a dimension (e.g., depth) of the groove proximate to the inlet port may be greater than a dimension (e.g., depth) of the groove proximate to the outlet port. As another example, a cross-sectional size, area, etc., of the groove proximate the inlet port may be greater than the cross-sectional size, area, etc., of the groove proximate the inlet port. This reduction in dimension, from the inlet port to the outlet port, promotes the flow of the sealant by increasing its velocity. The sealant flows faster through the smaller area while maintaining the same volume of the sealant. Given that the outlet port (or portions of the groove) are located distant from the inlet port, promoting the flow of sealant in this manner assists in sealing the mount to the surface and preventing the ingress of liquid into the surface.

Alternatively, rather than the sealant being injected into the groove, for example, the sealant may be non-injectable, non-flowable, etc. In these examples, the sealant may disposed in the groove prior to installation of the mount onto the surface. For example, the sealant may represent a seal (e.g., butyl seal) disposed into the groove. A shape of the seal may be complimentary to the groove. Alternatively, stripes of the seal ant, for example, butyl tape, may be cut and disposed within the groove. Still, in an embodiment, the sealing structure may include both flowable and non-flowable sealants.

The stanchion may include a channel that receives a fastener for attaching a rail to the mount. The rail may support, whether directly or indirectly, one or more solar panel modules. For example, after installation of the mount onto the surface the rail may be attached to the stanchion. The rail may be supported by any number of the stanchions disposed across any number of mounts attached to the surface. The fastener may disposed through the rail and the channel and fastened into a nut, for example. Tightening the fastener secures the rail to the stanchion. Prior to tightening the fastener, however, the fastener may be adjusted within the channel to raise and lower the rail by various heights above the surface. Once at a desired height, the fastener may be tightened. However, rather than attaching to the rail, other components, such as brackets, clamps, mounts, etc., may attach to the stanchion. These components may in turn attach to the rail and/or the solar panel modules.

In an embodiment, the stanchion may include a first arm and a second arm. The channel may be disposed between the first arm and the second arm. In an embodiment, the channel may be open-ended at a location spaced apart from the top of the base to permit insertion of the fastener. Alternatively, the channel may be enclosed. Regardless, the fastener may be translatable within the channel before tightening the fastener.

In an embodiment, the first arm and the second arm may include teeth (e.g., grooves, notches, etc.) that mate, adjoin, or otherwise engage with suitable features of the rail, brackets, etc. For example, in addition to the fastener being used to secure the rail to the mount, an engagement between the teeth of the first arm and the second arm, with the teeth of the rail, for example, may secure the rail in position.

The mount may be used on any suitable surface to which the solar panel modules are ultimately supported. For example, the mount may be used on a pitched roof, a flat roof, roofs of different compositions, such as composite shingle, metal, cedar shingle, etc. Although referred to as a mount, the mount may additionally or alternatively be referred to as a bracket, clamp, attachment apparatus, attachment mechanism, mounting system, etc. Moreover, although described herein as supporting solar panel modules, the mounts may be used to support other components, attachments, etc. Still, the sealing structures as described herein, such as the grooves and/or the sealant used to seal the mount against the based, may be used in applications other than solar panel modules.

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment, or instance, may be combined with the features of other embodiments or instances. Such modifications and variations are intended to be included within the scope of the disclosure and appended claims.

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

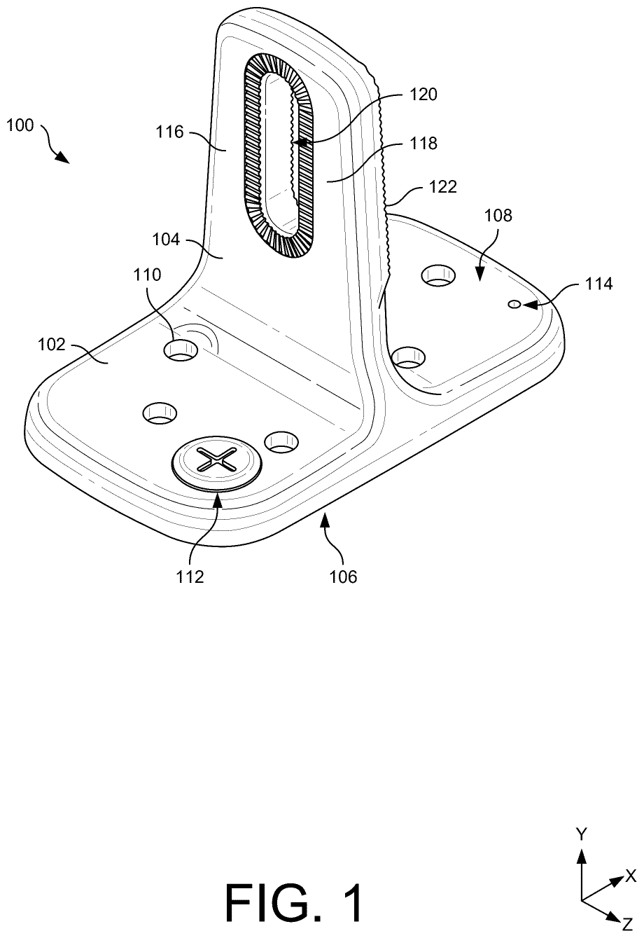

FIG. 1 illustrates a top perspective view of an example mount 100 that is configured to attach to a surface, according to an embodiment of the present disclosure. In an embodiment, the mount 100 may include a base 102 and a stanchion 104 that extends from the base 102. The base 102 may include a bottom 106 configured to be disposed against the surface, while the stanchion 104 may be disposed above the surface for receiving one or more rails that support solar panel modules. The stanchion 104 may extend orthogonally from a top 108 of the base 102.

The base 102 may attach to the surface via fasteners disposed through apertures 110. The apertures 110 may be disposed through the base 102, between the top 108 of the base 102 and the bottom 106 of the base 102. The base 102 may include any number of the apertures 110, which may be disposed on either or both sides of the stanchion 104. As will be explained herein, the apertures 110 may be fluidly connected to a groove formed on, within, in, etc., the bottom 106 of the mount 100. When the fasteners are disposed through the apertures 110, the fasteners may be disposed through or at a location within the groove. Moreover, a sealant may be disposed within the groove, and when the fasteners are disposed through the apertures 110 into the surface, the sealant may seal around penetrations in the surface formed by the fasteners. This prevents an ingress of liquid into the surface at a location where the fasteners penetrate the surface. In an embodiment, the sealant may locally seal around the fasteners as compared to sealing an entirety of the bottom 106 against the surface. In other words, since the penetrations into the surface represent points of ingress for liquid, the sealant may be disposed around and adjacent to these penetrations. Washers, such as an ethylene propylene diene monomer (EPDM) washer and/or a stainless steel washer, may be disposed between a head of the fastener and the top 108 of the base 102 to prevent an ingress of liquid into the apertures 110 and/or the groove, from the top 108.

A shape of the groove may be complimentary to, or accommodate, the fasteners and/or the apertures 110. For example, the groove may zig-zag, serpentine, cross-cross etc., between the apertures 110 such that the sealant may seal around the fasteners. The groove may be continuous between the apertures 110. As an example, if the mount includes six of the apertures 110, then the groove may be disposed between the six of the apertures.

In an embodiment, the sealant may be an injectable or flowable sealant dispersed into the groove. For example, the top 108 of the base 102 may define an inlet port 112 (e.g., orifice, etc.) into which a nozzle is insertable. The inlet port 112 is fluidly connected to the groove. As the sealant is injected into the groove, the sealant flows from the inlet port 112, throughout the groove, to an outlet port 114 (e.g., orifice, etc.). The outlet port 114 may provide a vent for air to escape as the air is urged out the groove via the sealant. The sealant may exit the outlet port 114 to visually indicate to an installer that the groove is filled. The sealant may be injected into the groove once the mount 100 has been secured into the surface via the fasteners.

The inlet port 112 and the outlet port 114 are shown as being located at corners or locations on the base 102. These locations, from a first location to a second location spaced apart from one another, may promote the flow of the sealant throughout the groove. The inlet port 112 may be located at a first end of the groove while the outlet port 114 may be located at a second end of the groove. Noted above, between the inlet port 112 and the outlet port 114, the groove may take a plurality of paths, shapes, routes, etc. However, although discussed as being a flowable sealant, in an embodiment, non-flowable sealants may be used to seal the mount 100 against the surface.

The stanchion 104 may include a first arm 116 and a second arm 118. Moreover, a channel 120 may be disposed at least partially between the first arm 116 and the second arm 118. The channel 120 may receive a fastener for attaching the rail to the stanchion 104, or more generally, the mount 100. For example, the fastener may be disposed through the rail and the channel 120, and threaded into a nut. Tightening the fastener causes the rail to become secured to the mounting. Prior to tightening the fastener, however, the fastener may be translated within the channel 120 to adjust a height of the rail above the surface.

In an embodiment, the first arm 116 and the second arm 118 may include teeth 122 (e.g., grooves, notches, etc.) that mate, adjoin, or otherwise engage with suitable features of the rail. The teeth 122 of the first arm 116 and the second arm 118 may interlock with the teeth of the rail, respectively, to secure the rail in position on the stanchion 104. The teeth 122 may be disposed on either side of the stanchion 104.

Although the rail is described as attaching directly to the stanchion 104, in an embodiment, other brackets, clamps, etc., may be used to attach the rail to the stanchion 104. Still, rail-less embodiments may be used to attach the solar panel modules to the surface. For example, in an embodiment, the solar panel modules may attach directly to the mounts 100.

The mount 100 may be formed from any suitable material, such as plastic, metal (e.g., aluminum), composites, etc. Suitable manufacturing techniques include injection molding, milling, machining, etc.

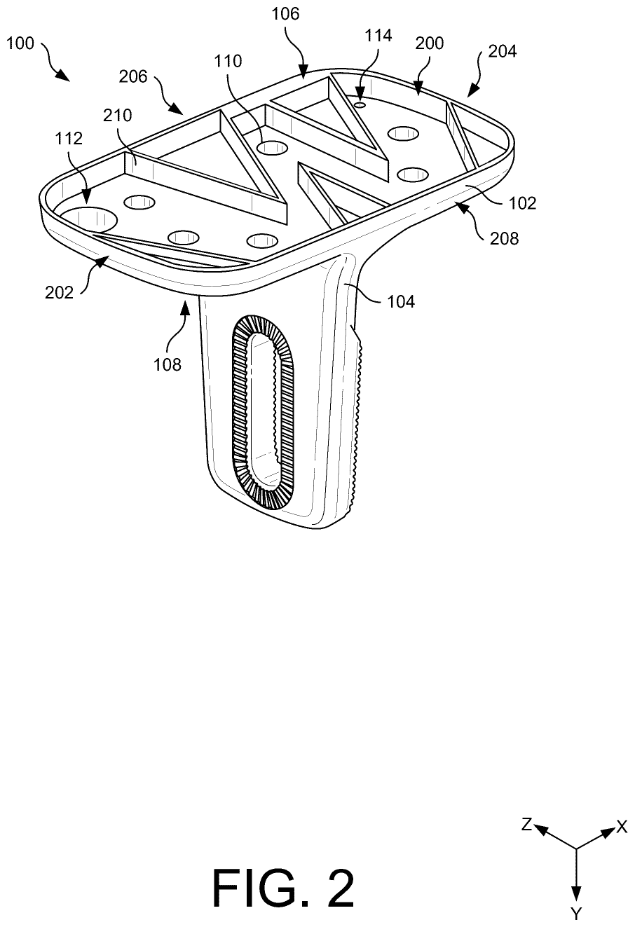

FIG. 2 illustrates a bottom perspective view of the mount 100, according to an embodiment of the present disclosure. As introduced above in FIG. 1, the mount 100 may include a groove 200 formed in the bottom 106. The groove 200 may extend between the inlet port 112 and the outlet port 114. The groove 200 is shown extending between a first end 202 of the mount 100 and a second end 204 of the mount 100 spaced apart from the first end 202 (e.g., in the X-direction). Between the first end 202 and the second end 204, the groove 200 may zig-zag, for example, between a first side 206 of the mount 100 and a second side 208 of the mount 100.

The apertures 110 may be fluidly connected to the groove 200 such that as the fasteners are disposed through the apertures 110, the fasteners extend through the groove 200. As introduced above, when a sealant is introduced into the groove 200 the sealant seals around the fasteners. Accordingly, the disposition of the fasteners through the groove 200, or at a location within the groove 200, seals the penetrations into the surface. An example sealant may include butyl, silicone, rubber, etc.

In an embodiment, the groove 200 is defined by one or more sidewalls 210. The sidewalls 210 help to retain the sealant within the groove 200 and route the sealant from the inlet port 112 to the outlet port 114. As the sealant is routed from the inlet port 112 to the outlet port 114, noted above, the sealant flows around the fasteners and is directed by the sidewalls 210. A bottom of the groove 200, which is open along the bottom 106 of the base 102, is enclosed via the surface given that the mount 100 is attached to the surface.

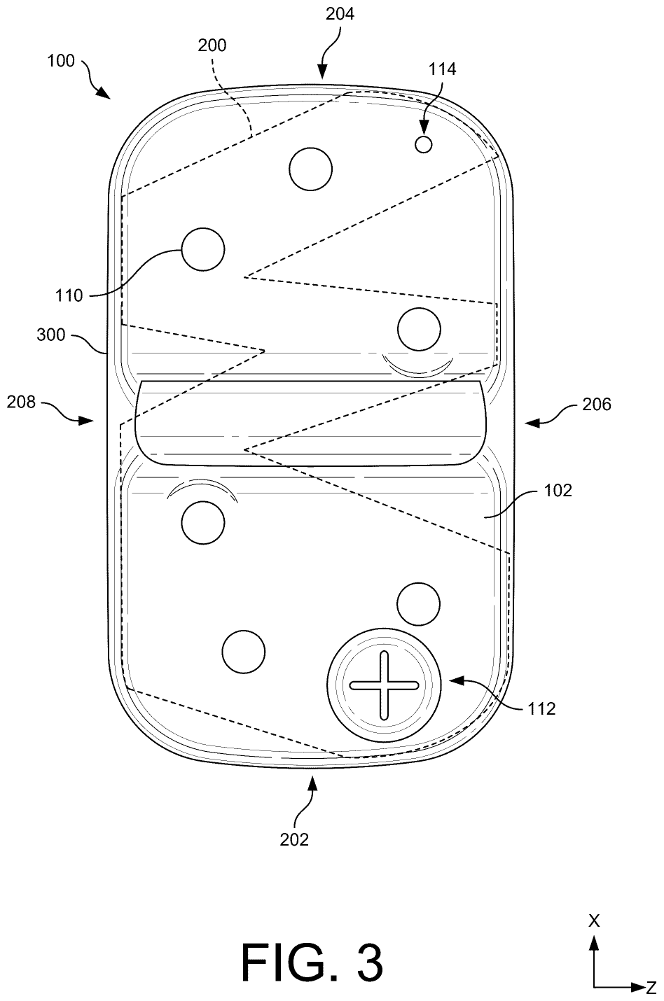

FIG. 3 illustrates a top planar view of the mount 100, according to an embodiment of the present disclosure. The groove 200, which is shown in dashed lines in FIG. 3, extends between the inlet port 112 and the outlet port 114. As shown, the groove 200 zig-zags between the first side 206 and the second side 208 as the groove 200 extends from the first end 202 to the second end 204. The groove 200 is also disposed internal to a perimeter 300 of the base 102.

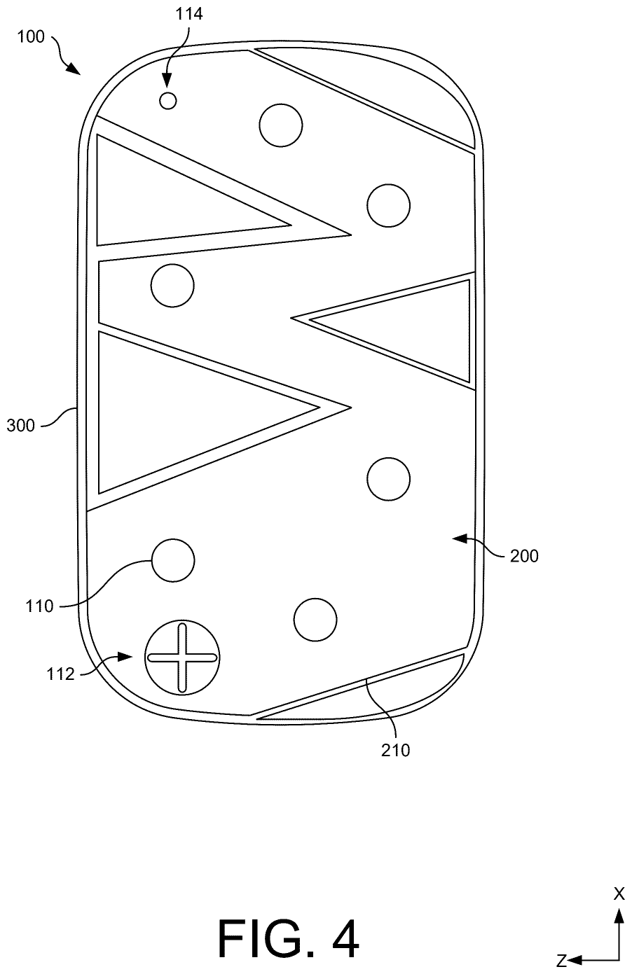

FIG. 4 illustrates a bottom planar view of the mount 100, according to an embodiment of the present disclosure. The groove 200 is defined at least in part by the sidewalls 210. The sidewalls 210 help direct the sealant from the inlet port 112 to the outlet port 114, as well as around the fasteners disposed through the apertures 110. As shown, the apertures 110 may be disposed internal to the groove 200, such as within the sidewalls 210. With this configuration, the sealant is permitted to flow around the fasteners once disposed through the apertures 110. In some instances, the apertures 110 may be disposed within a center of the groove 200, between the sidewalls 210.

The groove 200 is shown being disposed within the perimeter 300 of the base 102. In an embodiment, an area of the groove 200 may be less than an area of the base 102. For example, the area of the groove 200 may be a portion of the area of the base 102. In an embodiment, the area of the groove 200 may be less than fifty percent of the area of the base 102. Limiting the sealant to the groove 200, as compared to an entirety of the base 102, may seal the fasteners locally around the penetrations as compared to sealing an entirety of the base 102 against the surface. This may not only reduce an installation time but may also reduce the amount of sealant necessary to seal the mount 100 against the surface.

Although a particular shape, path, configuration, etc., of the groove 200 is shown, other variations are envisioned. For example, while the groove 200 is shown having a “W” shape, for example, the groove 200 may be “Z” shaped, “U” shaped, “C” shaped, etc. In such instances, the groove 200 may follow any zig-zag, serpentine, etc., path. Moreover, generally the groove 200 may take any path between the inlet port 112 and the outlet port 114.

The groove 200 may include different widths, for example, that extend between the sidewalls 210. In an embodiment, the groove 200 may include a constant or similar width that extends between the sidewalls 210. However, in an embodiment, the groove 200 may have a different or varied width that extends between the sidewalls 210. The width may be defined by a central line, path, arc, curve, etc., disposed through or along a center of the groove 200. A distance between the central line and the sidewalls 210 may be different along the length of the groove 200.

In an embodiment, the base 102 may include more than one groove, where each groove may have a respective inlet port and an outlet port. A first groove may accommodate first fasteners of the fasteners, while a second groove may accommodate second fasteners of the fasteners. Accordingly, more than one groove may be used to channel the sealant to seal around the fasteners. The seals may be different or similar to one another in size, shape, the number of fasteners they accommodate, etc.

Although the mount 100 is described in use with a flowable sealant, other sealants may be used with the mount 100. For example, an adhesive sealant may be disposed within the groove 200 prior to installation of the mount 100 onto the surface. When the fasteners are driven through the apertures 110 and into the surface, the fasteners may be disposed through the adhesive sealant. As another example, a seal, gasket, or washer may be disposed in the groove 200. In an embodiment, both flowable and non-flowable sealants may be used in combination with the mount 100. For example, both flowable and non-flowable sealants may be disposed in the groove 200.

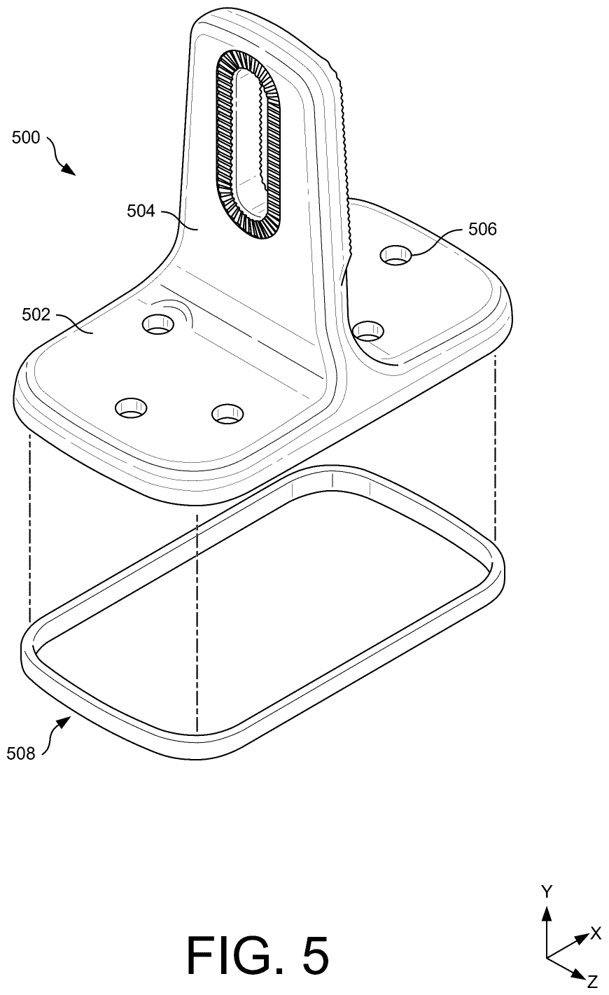

FIG. 5 illustrates a top perspective view of an example mount 500, according to an embodiment of the present disclosure. The mount 500 may be similar to the mount 100. For example, the mount 500 may include a base 502 and a stanchion 504 that extends from the base 502. The base 502 further includes apertures 506 through which fasteners are disposed for attaching the mount 500 to the surface.

Compared to the mount 100, however, the mount 500 may include a seal 508 that seals the mount 500 against the surface. The seal 508 may be retained, or received, by a groove disposed on a bottom of the mount 500. The seal 508 may extend around a perimeter of the base 502. The seal 508 may be disposed around, enclose, surround, etc., the apertures 506 (and consequently, the fasteners are disposed through the apertures 506). In this sense, the apertures 506 may not intersect with the seal 508.

In an embodiment, sealant may be applied to an end of the fasteners disposed through the apertures 506. For example, the sealant may be applied to the end of the fasteners, whether as a blob, ball, squirt, etc. As the fasteners are driven into the surface, this sealant may help seal the penetrations into the surface. Moreover, EPDM and/or stainless steel washers may be disposed between a head of the fasteners and the base to seal the apertures 506 from an ingress of liquid.

Although not shown, in an embodiment, the mount 500 may include the seal 508 and a groove that receives sealant for sealing the fasteners disposed through the apertures 506. In this sense, a mount may represent a combination of the mount 500 and the mount 100 as discussed above. Here, the seal 508 may seal around the periphery of the mount, while the sealant injected into the groove may seal around the fasteners. Moreover, the seal 508 may prevent the sealant from leaking beyond a periphery of the base 502, and/or help retain the sealant within the perimeter of the base 502. In such an embodiment, the mount may include an inlet port and an outlet port.

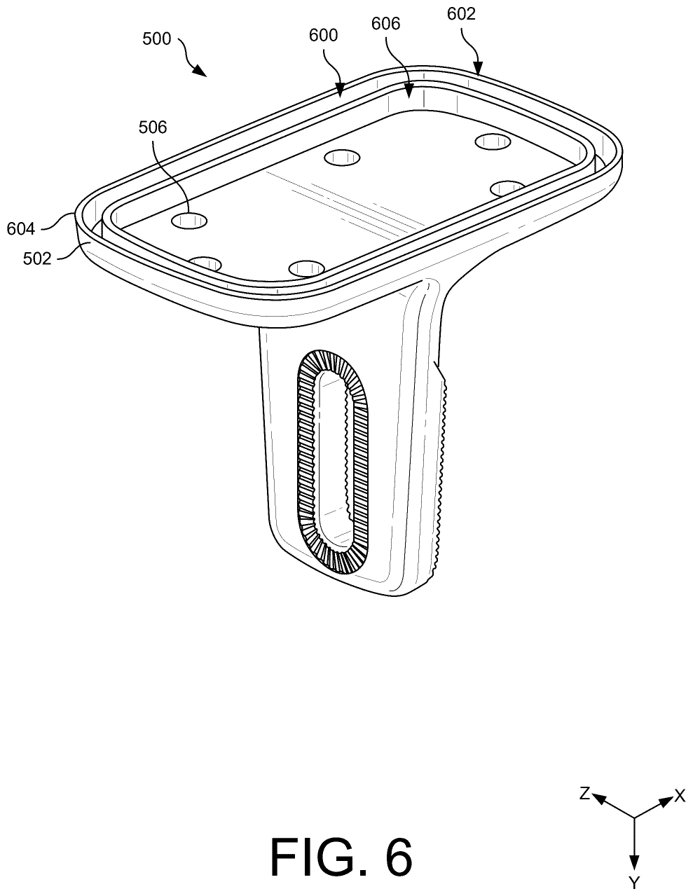

FIG. 6 illustrates a bottom perspective view of the mount 500, according to an embodiment of the present disclosure. The base 502 defines a groove 600 (e.g., channel, trough, etc.) formed in a bottom 602. The seal 508 is configured to be disposed in the groove 600. In FIG. 6, the seal 508 is shown as being absent, however, the groove 600 may be sized and shaped to accommodate the seal 508. As shown, the groove 600 may be disposed around a perimeter 604 of the base 502.

The apertures 506 may extend through an interior region 606 of the base 502, where the interior region is disposed internal to the seal 508. In this manner, the seal 508, once disposed against the surface, may seal around an outside of the fasteners as compared to the sealant being localized around the fasteners. Other ways to express the sealing may include that the fasteners are disposed internal to a perimeter of the seal 508, that the fasteners are disposed within the seal 508, that the fasteners are spaced apart from the seal 508, and so forth.

Although the seal 508 is described as being disposed around the periphery of the base 502, in an embodiment, the seal 508 may serpentine along the bottom 602 of the base 502, around the apertures 506, in between the apertures 506, etc. For example, the groove 600 may, in some areas, not be disposed along the periphery but may extend inwards towards a center of the base 502, to serpentine around the apertures 506, and so forth. Accordingly, the shape or path of the groove 600, as well as a shape of the seal 508, may be different than shown and described.

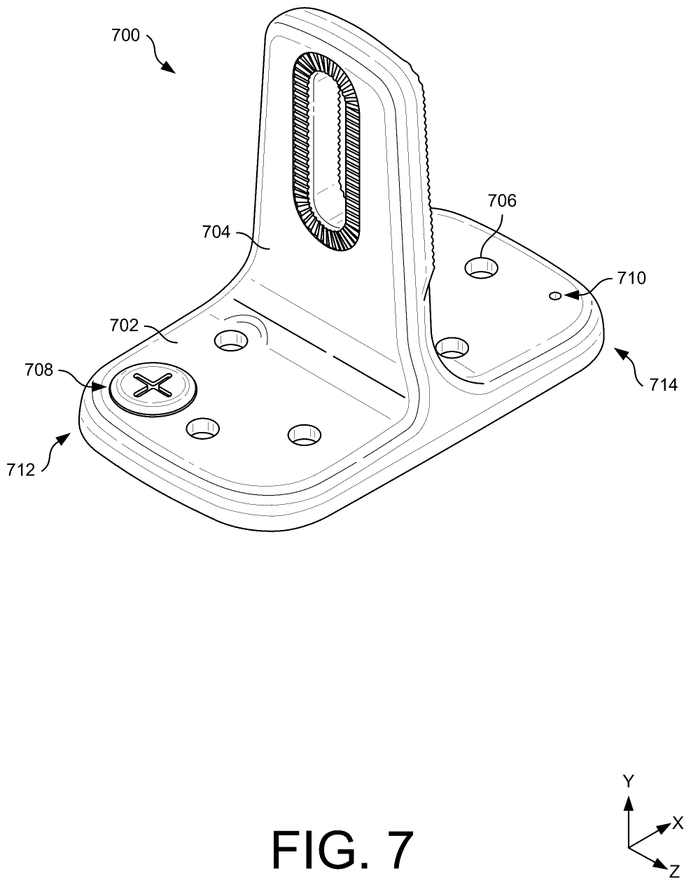

FIG. 7 illustrates a top perspective view of an example mount 700, according to an embodiment of the present disclosure. The mount 700 may be similar to the mount 100 as discussed above. For example, the mount 700 may include a base 702, a stanchion 704, apertures 706 disposed through the base 702 for penetrations into the surface, and so forth.

The mount 700 may also include an inlet port 708 associated with injecting flowable sealant into a groove (e.g., similar to the groove 200) and an outlet port 710 associated with venting air from within the groove. The inlet port 708 and the outlet port 710 may be located on diametrically opposed corners of the base 702. The inlet port 708 may be located proximate to a first corner 712 and the outlet port 710 may be located proximate to a second corner 714, diagonally opposed from the first corner 712. A groove may traverse through the mount 700, between the inlet port 708 and the outlet port 710. Spacing the inlet port 708 and the outlet port 710 apart from one another may promote the flow of sealant throughout the groove and assist in sealing the penetrations into the surface created by the fasteners. In this manner, the sealant may flow in a constant or consistent direction, or follow a single path, from the inlet port 708 to the outlet port 710. Comparatively, if the inlet port 708 were located elsewhere, such as at a central location between ends of the groove, the sealant may have to flow in multiple directions (e.g., in a first direction towards a first end of the groove and a second direction towards a second end of the groove). This, however, may result in an inadequate seal of the mount 700 against the surface.

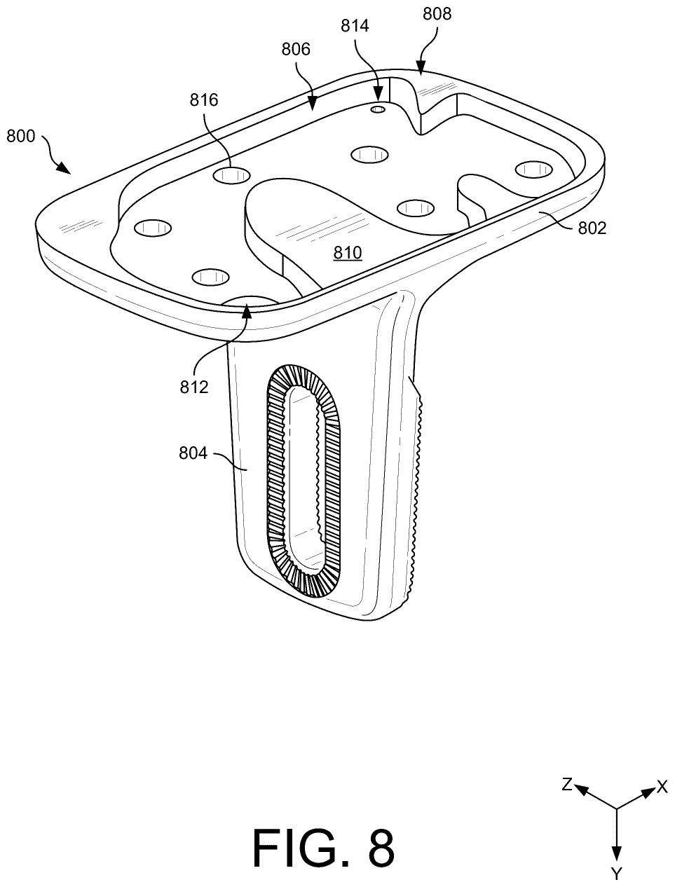

FIG. 8 illustrates a bottom perspective view of an example mount 800, according to an embodiment of the present disclosure. The mount 800 may be similar to the mount 100 and/or the mount 500 as discussed above. For example, the mount 800 may include a base 802 and a stanchion 804 that extends from the base 802. The base 802 may include a cavity 806 formed in a bottom 808 of the base 802. The cavity 806 may be similar to the groove 200 in the base 102, for example, but as shown, may have a different shape, profile, etc. For example, the cavity 806 may have different sections, arms, limbs, etc. In an embodiment, the cavity 806 may be formed via one or more raised protrusions 810 (e.g., bosses, pillars, posts, etc.). The protrusions 810, or a surface thereof, may be disposed against the surface when the mount 800 is attached to the surface.

The cavity 806 is configured to be filled with a sealant, such as a sealant that is injected into the cavity 806 from an inlet port 812. As similarly discussed above with the groove 200, the sealant may flow from the inlet port 812 to an outlet port 814. During which, the sealant may traverse or seal around fasteners disposed through apertures 816 in the base 802. The apertures 816 may not be disposed through the base 802 at locations corresponding to the protrusions, but instead, locations within the cavity 806.

The cavity 806 may also extend in multiple directions. For example, compared to the groove 200, which may extend from the inlet port 112 to the outlet port 114, and where the sidewalls 210 urge the sealant in a single direction along the length of the groove 200, the cavity 806 may have different forks, intersections, etc. At these locations, the sealant may extend in different directions to fill the cavity 806.

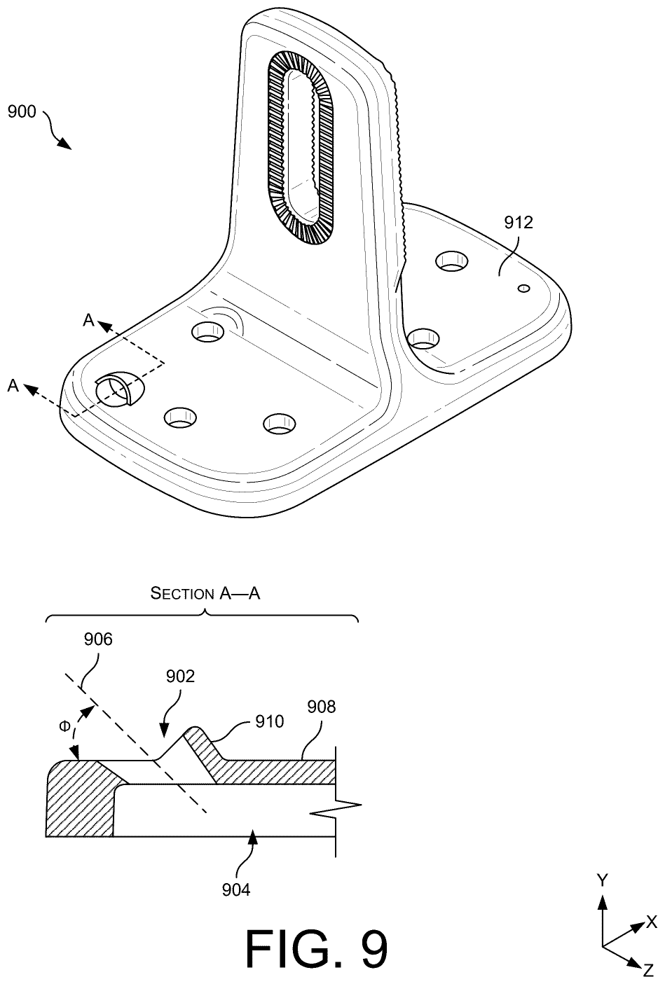

FIG. 9 illustrates an example mount 900, according to an embodiment of the present disclosure. The mount 900 may be similar to the mount 100, the mount 500, and/or the mount 800. Compared to the mount 100, the mount 500, and/or the mount 800, an inlet port 902 of the mount 900 is shown being conical in nature. The conical nature of the inlet port 902 may accommodate a nozzle used to inject the sealant into a groove 904, or cavity, of the mount 900. For example, a nipple, nozzle, etc., of a container for injecting the sealant into the groove 904 may be disposed at least partially within the inlet port 902. In an embodiment, the inlet port 902 may be defined by an axis 906, and the axis 906 may be disposed at an angle Φ relative to a top 908 of a base 912. The angle Φ may be acute.

Additionally, a flange 910 may be disposed at least partially around (e.g., at least on one side) the inlet port 902. In an embodiment, the flange 910 may be disposed above the top 908 of the base 912. The flange 910 may assist in directing the nozzle of the container into the inlet port 902.

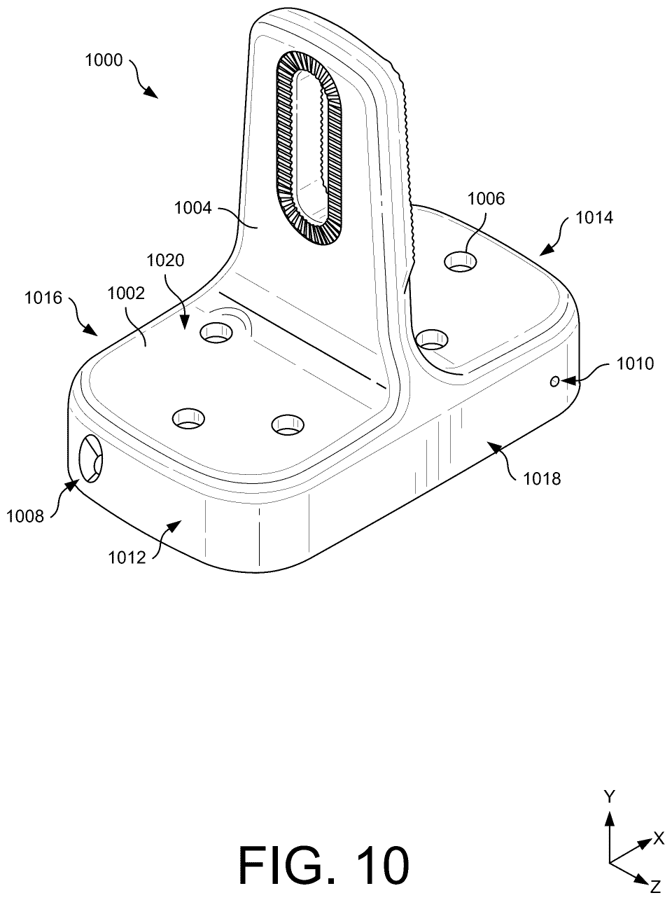

FIG. 10 illustrates an example mount 1000, according to an embodiment of the present disclosure. The mount 1000 may be similar to the mount 100, the mount 500, the mount 800, and/or the mount 900 as discussed above. The mount 1000 may include a base 1002, a stanchion 1004 that extends from base 1002, and apertures 1006 disposed through the base 1002 for attaching the mount 1000 to the surface. However, an inlet port 1008 and/or an outlet port 1010, which may be fluidly connected to a groove that receives a sealant, may be located along sides of the base 1002. That is, compared to the mount 100, the mount 500, the mount 800, and/or the mount 900 in which the inlet ports and the outlet ports are located along the top, the inlet port 1008 may be located along one or more ends and/or sides of the base 1002.

For example, the base 1002 may include a first end 1012, a second end 1014 spaced apart from the first end 1012 (e.g., in the X-direction), a first side 1016, and a second side 1018 spaced apart from the first side 1016 (e.g., in the Z-direction). The inlet port 1008 may be located at or along the first end 1012. The outlet port 1010 may be located at or along the second side 1018. Between the inlet port 1008 and the outlet port 1010, the groove may serpentine, zig-zag, cross-cross, etc. Moreover, to accommodate the inlet port 1008 and the outlet port 1010 along the one or more ends and/or sides, the base 1002 may include an increased thickness (e.g., in the Z-direction) as compared to the mount 100, the mount 500, the mount 800, and/or the mount 900.

Although the inlet port 1008 and the outlet port 1010 are shown at a certain location, in an embodiment, at least one of the inlet port 1008 or the outlet port 1010 may be located along the first end 1012, the second end 1014, the first side 1016, or second side 1018. For example, the inlet port 1008 may be located at the first end 1012, while the outlet port 1010 may be located along a top of the base 1002. In an embodiment, the inlet 1008 may be conically shaped to receive a nozzle or neck of a caulk tube. In an embodiment, an opening of the inlet 1008 may be oriented towards a top 1020 of the base 1002 to permit the nozzle of the caulk tube to be inserted into the inlet 1008 without the caulk gun (or caulk tube) contacting the surface on which the mount 1000 is disposed. Alternatively, the opening of the inlet 1008 may be oriented towards the first end 1012, the first side 1016, or the second side 1018. The inlet 1008 may also, in an embodiment, not be conically shaped.

In some instances, disposition of the inlet port 1008 along the ends and/or the sides may promote an increased flow of sealant. For example, when the inlet port is on the top, the sealant may be injected into the groove (or the cavity) at angle transverse to a desired directional flow of the sealant. This may provide resistance or pressure that inhibits the flow of the sealant. Comparatively, if the sealant is injected at an angle parallel to the desired directional flow of the sealant, the sealant may more easily flow between the inlet port 1008 and the outlet port 1010.

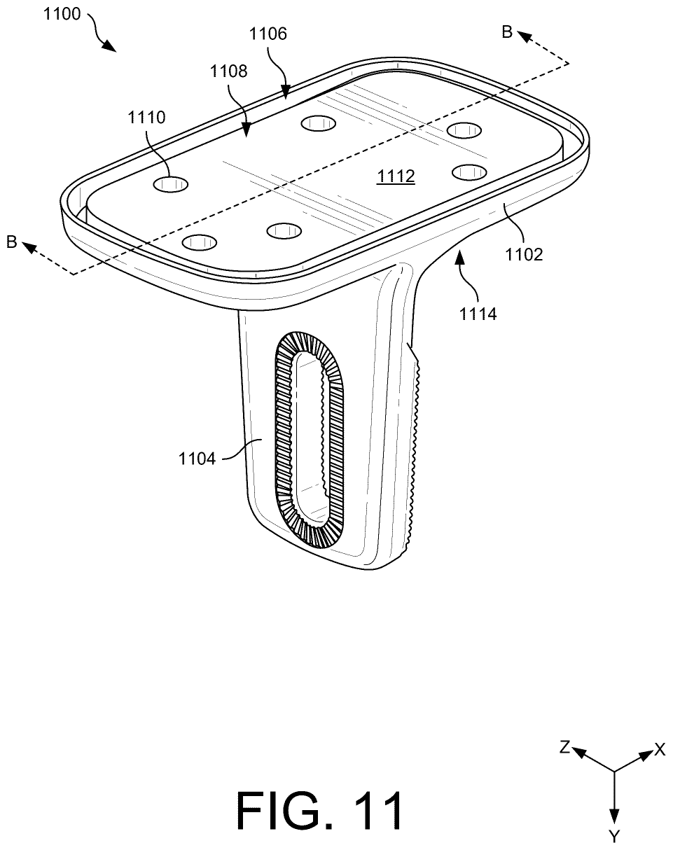

FIG. 11 illustrates a bottom isometric view of an example mount 1100, according to an embodiment of the present disclosure. The mount 1100 includes a base 1102 and a stanchion 1104 that extends from the base 1102. The base 1102 may define a groove 1106 on a bottom 1108. The groove 1106 may extend around a perimeter of periphery of the base 1102. The groove 1106 may also be disposed around apertures 1110 disposed through the base 1102, which accommodates the fasteners for attaching the mount 1100 to the surface. As such, the groove 1106 may be disposed around the apertures 1110, or stated alternatively, the apertures 1110 may be disposed within a perimeter of the groove 1106. In an embodiment, the apertures 1110 may be disposed through a central region 1112 of the mount 1100, where the central region 1112 is encircled, surrounded by, etc., the groove 1106.

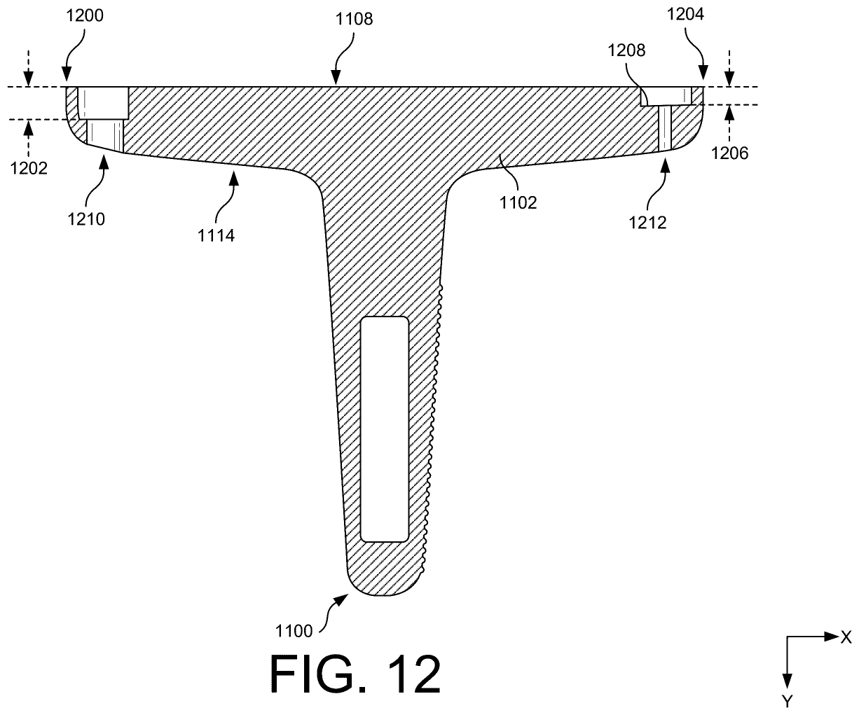

A top 1114 of the base 1102 may include an inlet port into which the sealant is injectable. The inlet port is fluidly connected to the groove 1106. The top 1114 of the base 1102 may also include an outlet port through which air within the groove 1106 is vented during injection of the sealant. As will be explained herein in FIG. 12, the groove 1106 may include different depths (e.g., in the Y-direction). For example, proximate to the inlet port, the groove 1106 may include a first depth and proximate to the outlet port, the groove 1106 may include a second depth. The second depth may be less than the first depth. In other words, the depth of the groove 1106 may be less at the outlet port compared to the inlet port. In an embodiment, the reduced depth may promote the flow of sealant throughout the groove 1106 given the reduction in volume of the groove 1106. In an embodiment, the depth of the groove 1106 may gradually lessen (e.g., taper) between the inlet port and the outlet port.

FIG. 12 illustrates a cross-sectional view of the mount 1100, taken along line B--B of FIG. 11, according to an embodiment of the present disclosure. As introduced above, the groove 1106 may include varied depths. For example, proximate to a first end 1200 of the base 1102, the groove 1106 may include a first depth 1202 (e.g., in the Y-direction). Proximate to a second end 1204 of the base 1102, the groove 1106 may include a second depth 1206 (e.g., in the Y-direction) that is less than the first depth 1202. The first depth 1202 and the second depth 1206 may be defined between the bottom 1108 and a surface 1208 of the groove 1106.

The base 1102 may also define an inlet port 1210 and an outlet port 1212 fluidly connected to the groove 1106. The inlet port 1210 may be located proximate to the first end 1200 and the outlet port 1212 may be located proximate to the second end 1204. Generally, the groove 1106 may have a reduced depth from the inlet port 1210 to the outlet port 1212. This reduction in depth, for example, may promote the flow of the sealant injected into the inlet port 1210. That is, because of the reduced volume of the groove 1106, from the inlet port 1210 to the outlet port 1212, a speed of the sealant flowing through the groove 1106 may increase between the inlet port 1210 and the outlet port 1212. Although the inlet port 1210 and the outlet port 1212 are shown located along the top 1114, the inlet port 1210 and the outlet port 1212 may be located along sides or the ends of the mount 1100. The bottom 1108 may also be planar such that the mount 1100 is disposed flush against the surface.

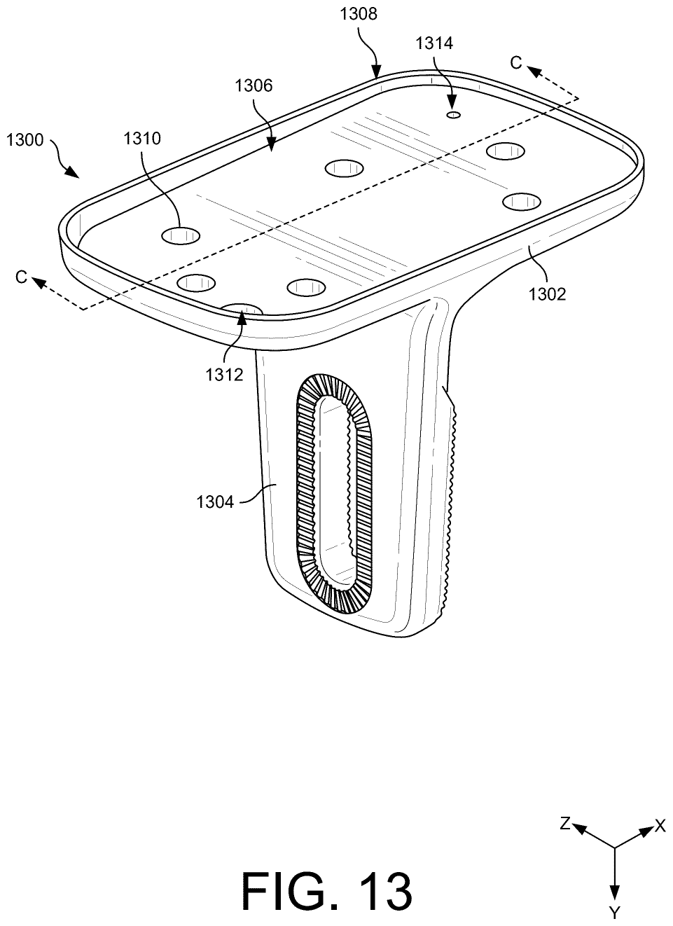

FIG. 13 illustrates a bottom isometric view of an example mount 1300, according to an embodiment of the present disclosure. The mount 1300 includes a base 1302 and a stanchion 1304 that extends from the base 1302. The base 1302 may define a cavity 1306 disposed within a bottom 1308. Compared to the mount 1100, the sealant injected into the cavity 1306 may be disposed around fasteners disposed through apertures 1310 in the base 1302. Stated alternatively, compared to the groove 1106 in which the sealant is disposed on a select portion of the bottom, the sealant in the cavity 1306 may be disposed substantially along an entirety of the bottom 1308. As the sealant is injected into the cavity 1306, the sealant may flow from an inlet port 1312 to an outlet port 1314. Generally, the cavity 1306 may have a reduced depth from the inlet port 1312 to the outlet port 1314. Similar to the groove 1106, the reduced depth from the inlet port 1312 to the outlet port 1314 may promote the flow of sealant throughout the cavity 1306.

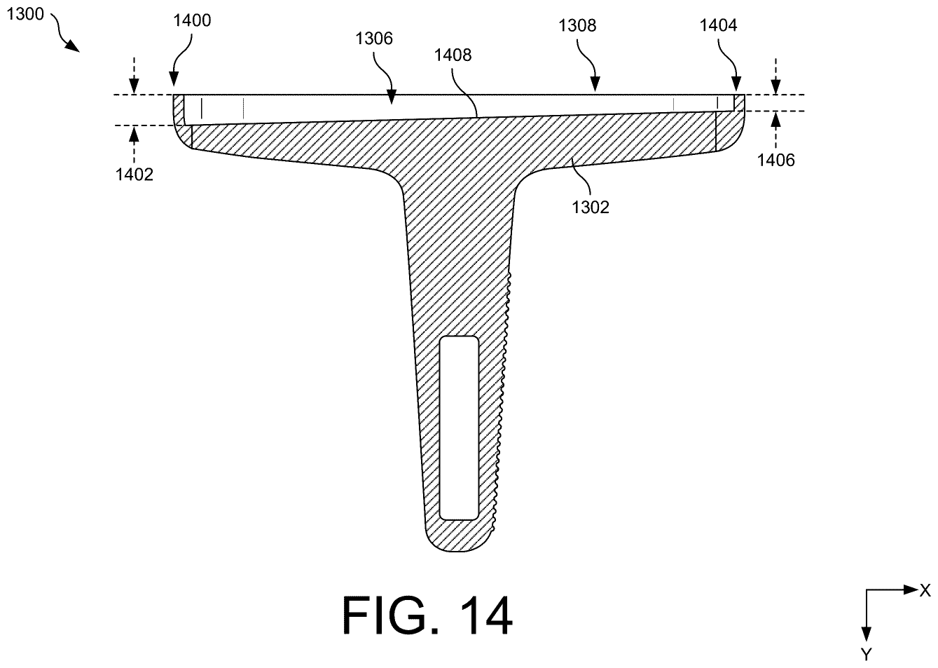

FIG. 14 illustrates a cross-sectional view of the mount 1300, taken along line C-C of FIG. 13, according to an embodiment of the present disclosure. The cavity 1306 may include varied depths. For example, proximate to a first end 1400 of the base 1302, the cavity 1306 may include a first depth 1402 (e.g., in the Y-direction). Proximate to a second end 1404 of the base 1302, the cavity 1306 may include a second depth 1406 (e.g., in the Y-direction) that is less than the first depth 1402. The first depth 1402 and the second depth 1406 may be defined between the bottom 1308 and a surface 1408 of the cavity 1306. The surface 1408 may gradually extend towards the bottom 1308 between the first end 1400 and the second end 1404. The bottom 1308 may also be planar such that the mount 1300 is disposed flush against the surface.

The base 1302 may also define the inlet port 1312 and the outlet port 1314 fluidly connected to the cavity 1306. The inlet port 1312 may be located proximate to the first end 1400 and the outlet port 1314 may be located proximate to the second end 1404. Generally, the cavity 1306 may have a reduced depth from the inlet port 1312 to the outlet port 1314. This reduction in depth may promote the flow of the sealant injected into the inlet port 1312. Although the inlet port 1312 and the outlet port 1314 are shown located along the top of the base 1302, the inlet port 1312 and the outlet port 1314 may be located along sides or the ends of the mount 1300.

Although the cavity 1306 is described as reducing in depth between the inlet port 1312 and the outlet port 1314 (e.g., in the Z-direction), the cavity 1306 may additionally or alternatively reduce in depth between sides of the base 1302 (e.g., in the Z-direction). Moreover, the reducing in depth between the inlet port 1312 and the outlet port 1314 may be linear, parabolic, curved, etc.

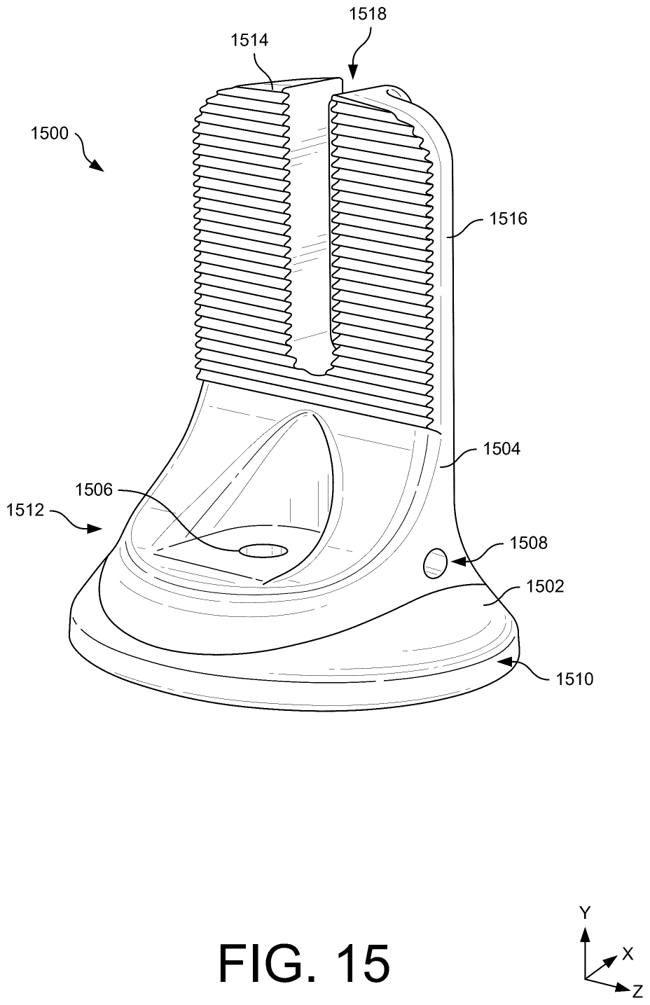

FIG. 15 illustrates a first top isometric view of an example mount 1500, according to an embodiment of the present disclosure. The mount 1500 may include a base 1502 and a stanchion 1504 that extends from the base 1502. The base 1502 may include an aperture 1506 to accommodate a fastener for attaching the mount 1500 to the surface. In an embodiment, the base 1502 may include a single aperture, whereby a single fastener may be used to attach the mount 1500 to the surface. This is compared to the previous embodiments of the mount whereby more than one fastener is used to attach the mount to the surface.

The mount 1500 may include an inlet port 1508 into which sealant is injected into a cavity, groove, etc., of the mount 1500. The inlet port 1508 may be located along a first side 1510 of the base 1502. An outlet port may be located along a second side 1512 of the base 1502, opposite the first side 1510. The inlet port 1508 and the outlet port may be located on opposite, or opposed, sides of the base 1502. This positioning of the inlet port 1508 and the outlet port may promote the flow of sealant into the cavity, throughout the cavity, and out the outlet port.

The stanchion 1504 may include a first arm 1514, a second arm 1516, and a channel 1518 defined therebetween. The channel 1518 may accommodate a fastener for attaching a rail, for example, to the stanchion 1504. In an embodiment, the inlet port 1508 may be located on a first side of the stanchion 1504, while the outlet port may be located on a second side of the stanchion 1504.

In other regards, the mount 1500 may be similar to embodiments as described in, for example, U.S. Pat. No. 10,171,026, issued Jan. 1, 2029, entitled “Structural Attachment Sealing System,” the entirety of which is herein incorporated by reference.

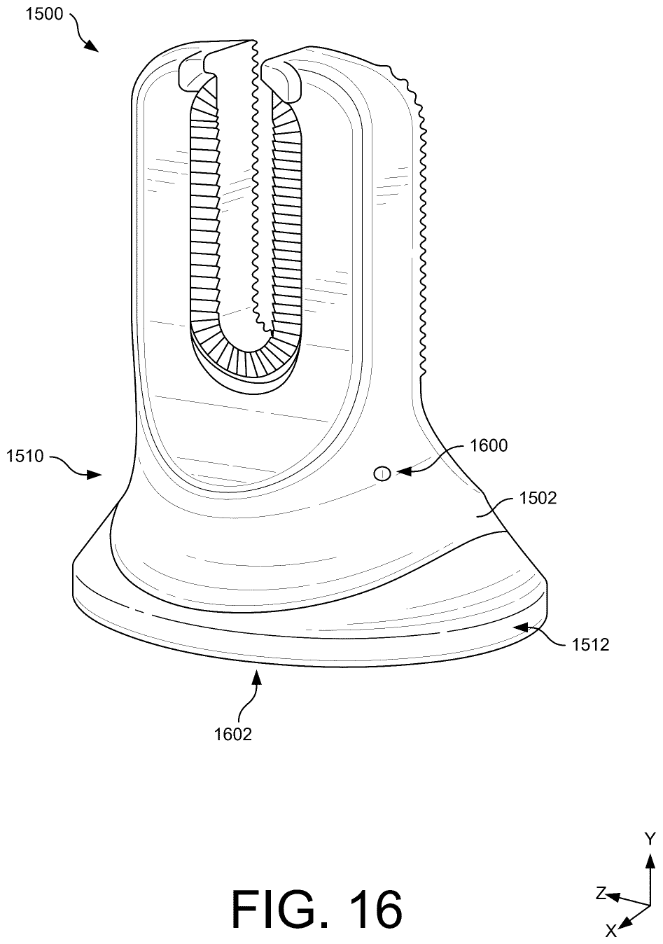

FIG. 16 illustrates a second top isometric view of the mount 1500, according to an embodiment of the present disclosure. As introduced above, the mount 1500 may include an outlet port 1600 formed in the base 1502, along the second side 1512. The outlet port 1600 may be spaced apart from a bottom 1602 of the mount 1500 such that as the sealant is injected into the cavity, the sealant fills the cavity and rises to vent out the outlet port 1600 (once the cavity becomes filled). Moreover, disposing the outlet port 1600 on an opposite side as the inlet port 1508 may promote filling of the cavity by urging the sealant to fill the cavity in a direction between the inlet port 1508 and the outlet port 1600. Comparatively, if the outlet port 1600 was located proximate to the inlet port 1508, the sealant would have to potentially reach locations in the cavity distant from inlet port 1508 and outlet port 1600. To accomplish such, an installer may have to manually plug the outlet port 1600 to prevent the sealant escaping prior to the cavity being filled with the sealant.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated, and may include indirect connections through one or more intermediary elements. Likewise, the terms “directly” and “indirectly” describe both physical contact between components and connections made through intermediate structures, mechanisms, or devices.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A mount to support a rail on which one or more solar panel modules are disposed, the mount comprising:
a base including:
a top,
a bottom opposite the top,
one or more apertures extending through the base, between the top and the bottom,
a groove formed in the bottom,
an inlet port disposed on the top and fluidly connected to the groove, and
an outlet port disposed on the top and fluidly connected to the groove; and
a stanchion extending from the top of the base, the stanchion including:
a first arm,
a second arm, and
a channel disposed at least partially between the first arm and the second arm, the channel to accommodate a fastener to attach the rail to the mount.

2. The mount of claim 1, wherein:
the base includes:
a first end,
a second end opposite the first end,
a first side, and
a second side opposite the first side;
the inlet port is located proximate to the first end;
the outlet port is located proximate to the second end; and
the groove extends from the first end to the second end, between the first side and the second side.

3. The mount of claim 1, wherein the groove includes at least one of a crisscross path, a serpentine path, or a zig-zag path between the inlet port and the outlet port.

4. The mount of claim 1, wherein the inlet port is disposed on a first side of the stanchion, and the outlet port is disposed on a second side of the stanchion.

5. The mount of claim 1, wherein a sealant is injectable into the inlet port.

6. The mount of claim 5, wherein:
individual apertures of the one or more apertures receive a fastener for securing the mount to a surface; and
the sealant flows around the fastener disposed through the individual apertures, at a location within the groove, as the sealant moves from the inlet port to the outlet port.

7. The mount of claim 1, wherein:
the groove is open along the bottom;
the mount attaches to a surface via a fastener disposed through individual apertures of the one or more apertures; and
when attached to the surface, the groove is enclosed along the bottom to promote a sealant to flow from the inlet port to the outlet port.

8. A mount comprising:
a base including a top and a bottom;
a stanchion extending from the top of the base;
a first port disposed on the top of the base;
a second port disposed on the top of the base;
one or more apertures disposed between the top and the bottom;
a groove disposed on the bottom and extending between the first port and the second port, the groove to receive a sealant for sealing the mount to a surface; and
a stanchion extending from the top of the base.

9. The mount of claim 8, wherein the one or more apertures are fluidly connected to the groove.

10. The mount of claim 8, wherein the groove is defined at least in part by one or more sidewalls formed in the bottom.

11. The mount of claim 8, wherein:
the groove includes a bottom surface:
the groove has a first depth extending from the bottom to the bottom surface proximate the first port; and
the groove has a second depth extending from the bottom to the bottom surface proximate to the second port, the second depth being less than the first depth.

12. The mount of claim 8, wherein:
a fastener extends through individual apertures of the one or more apertures to secure the mount to the surface; and
the sealant flows around a body of the fastener, at a location within the groove, to seal around the fastener.

13. The mount of claim 8, wherein:
the first port is located at a first end of the groove;
the second port is located at a second end of the groove; and
the groove is continuous between the first end and the second end.

14. The mount of claim 8, wherein a path of the groove, between the first port and the second port, at least one of crisscrosses between sides of the mount, serpentines between the sides of the mount, or zig-zags between the sides of the mount.

15. A mount for attaching solar panel modules to a surface, the mount comprising:
a base;
a groove formed in the base;
one or more apertures disposed through the base, the one or more apertures disposed internal to the groove, individual apertures of the one or more apertures to receive a first fastener for attaching the mount to the surface;
a first port fluidly connected to the groove, the first port being associated with injecting a sealant into the groove;
a second port fluidly connected to the groove, the second port permitting air within the groove to vent as the sealant is injected into the groove; and
a stanchion extending from the base, the stanchion including a channel to receive a second fastener for attaching the solar panel modules to the mount.

16. The mount of claim 15, wherein:
the base includes:
a top,
a bottom opposite the top,
a first end,
a second end opposite the first end;
a first side, and
a second side opposite the first side;
the one or more apertures are disposed between the top and the bottom;
the first port is disposed on one of the first end, the first side, or the second side; and
the second port is disposed on one of the second end, the first side, or the second side.

17. The mount of claim 15, wherein the groove extends around a periphery of the base.

18. The mount of claim 15, wherein the one or more apertures are fluidly connected to the groove such that the sealant seals around the first fastener disposed through the individual apertures.

19. The mount of claim 15, wherein:
the groove includes a first depth proximate to the first port; and
the groove includes a second depth proximate to the second port, the second depth being less than the first depth.

20. The mount of claim 15, wherein the base includes one or more sidewalls that form the groove between the first port and the second port.
